(19) United States
(12) Patent Application Publication
(10) Pub. No.: US 2022/0412296 A1
(43) Pub. Date: Dec. 29, 2022

(54) COMPONENT, IN PARTICULAR FUEL LINE OR FUEL DISTRIBUTOR, AND FUEL INJECTION SYSTEM

(71) Applicant: Robert Bosch GmbH, Stuttgart (DE)

(72) Inventors: Patrick Fayek, Leonberg (DE); Ralf Weber, Bretten (DE); Thomas Woehrle, Heilbronn (DE); Tobias Steiner, Weil Im Schoenbuch (DE)

(21) Appl. No.: 17/772,614

(22) PCT Filed: Sep. 25, 2020
(86) PCT No.: PCT/EP2020/076909

§ 371 Date: Jun. 15, 2022

(30) Foreign Application Priority Data
Oct. 28, 2019 (DE) 10 2019 216 523.0

(51) Int. Cl. F02M 55/02

(52) U.S. Cl. CPC F02M 55/025; F02M 2200/9076; F02M 2200/9069; F02M 2200/9061

(57) ABSTRACT

A component (3; 3′) for an injection system (1), in particular a high-pressure line (5) or a fluid distributor (2), including a base body (14; 13), at which a high-pressure input (15; 12) and at least one high-pressure output (16 through 19; 12′) are provided, at least the base body (14; 13) being at least essentially formed from an austenitic or martensitic material. It is provided that the material is developed as a grain-stabilized material.

### BACKGROUND INFORMATION

The present invention relates to a component, in particular a fuel line or a fuel distributor, for a fuel injection system. The present invention further relates to a fuel injection system that is preferably used as a fuel injection system for mixture-compressing, spark-ignited internal combustion engines. The present invention specifically relates to the field of fuel injection systems of motor vehicles in which fuel is injected directly into the combustion chambers of an internal combustion engine.

A fuel distributor rail for an internal combustion engine is known from EP 2 789 845 A1. Here, reference is made to the requirements that in the course of a performance increase at a constant or reduced displacement the discharge pressures increase, that an increase in the wall thickness takes place to ensure sufficient operational reliability, and that the available installation space remains the same, however. The individual components of the fuel distributor rail are further coupled to one another at 500° C. to 1150° C. with the aid of a high-temperature soldering process. This is why at least the distributor tube of the known fuel distributor rail is formed from a duplex steel made of preferably 0.1 weight percent to 5 weight percent of nickel, preferably 20 weight percent to 25 weight percent of chromium, and preferably 2.50 weight percent to 3.50 weight percent of molybdenum. Here, materials having material numbers 1.4462, 1.4162, 1.4362, and 1.4662 are used, in which a higher strength remains even after hard soldering.

The fuel distributor rail known from EP 2 789 845 A1 has the disadvantage that in the case of the above-mentioned materials an expansion coefficient or the modified expansion behavior of the fuel distributor rail may require essential constructive adaptations. Moreover, during the manufacturing the issue of poor machinability arises.

### SUMMARY OF THE INVENTION

The component according to the present invention having the features of Claim 1 and the injection system according to the present invention having the features of Claim 10 have the advantage that an improved design and functionality are enabled.

With the aid of the measures listed in the subclaims, advantageous refinements of the component indicated in Claim 1 and the injection system indicated in Claim 10 are possible.

At least the base body of the component is formed from a material that involves an austenitic or a martensitic material. A rust-proof austenite is preferably selected. A high strength is achieved as a result of grain stabilization. This, for example, enables an increase in a fluid pressure, which the fluid to be injected is subjected to, in the case of a constant or comparable geometry of the base body. A geometric adaptation, such as an increase in the wall thickness of the base body, may thus potentially be dispensed with. The increased strength may, however, also be used in a different manner. For example, a pressure increase may be enabled, while maintaining or even reducing the weight of the component. Furthermore, the material may be advantageously selected in such a way that a comparable expansion coefficient of the material results, as in the case of a conventional design.

Specifically, the component, in particular the base body, may be designed with reference to a system pressure that is greater than 35 MPa (350 bar). Such a design in particular relates to the application of a fuel injection system for gasoline or mixtures containing gasoline. It is then particularly advantageous if a refinement according to Claim 2 is implemented.

Advantageous possibilities of achieving grain stabilization of the material are indicated in Claims 3 and 4. Specifically in this case, a design may be implemented that prevents the formation of coarse grain in the temperature range of a hot shaping, as is indicated in Claim 5. This is then advantageous, in particular, in the case of a design according to Claim 6, which in particular illustrates an advantageous application in a forged fuel distributor rail. In contrast to a conventional design based on a material having the material number 1.4301, coarse grain formation may then be reduced. The provided design also results in an improved vibration resistance.

The microalloy for grain stabilization, which is preferably based on niobium and/or vanadium and/or titanium and/or aluminum, may preferably have a portion of approximately 0.005 weight percent to approximately 3.00 weight percent of the material overall. In this case, approximately 0.005 weight percent to approximately 2.50 weight percent of niobium, particularly preferably 0.008 weight percent to 0.8 weight percent of niobium, and/or approximately 0.005 weight percent to approximately 2.50 weight percent of vanadium, particularly preferably 0.008 weight percent to 0.8 weight percent of vanadium, and/or approximately 0.005 weight percent to approximately 1.50 weight percent of titanium, particularly preferably 0.008 weight percent to 0.8 weight percent of titanium, and/or approximately 0.005 weight percent to approximately 2.00 weight percent of aluminum, particularly preferably 0.008 weight percent to 0.8 weight percent of aluminum may be predefined.

One advantageous embodiment of the component is further indicated in Claim 7 that may be advantageously implemented by forging. In addition or alternatively, a grain stabilization may also be advantageous in other heat treatments, in particular in the case of hardening according to Claim 8. A selection of possible materials is indicated in Claim 9.

As a result of the grain stabilization, a light design of a component may thus, in particular, be implemented or maintained if high pressures or greater pressures, in particular pressures of more than 35 MPa, are to be implemented. Specifically, the development of a finer grain in the structure, for example as a result of a microalloy, advantageously has an effect on the resulting vibration resistance due to the higher strength, while having improved ductility at the same time. A reduction of the dimensions of the component and/or a lighter design of the component may be potentially enabled even at higher system pressures.

### BRIEF DESCRIPTION OF THE DRAWINGS

Preferred exemplary embodiments of the present invention are explained in greater detail in the following description with reference to the appended drawings in which corresponding elements are provided with matching reference numerals.

FIG. 1 shows in a schematic sectional illustration an injection system designed as a fuel injection system including a component designed as a fuel distributor according to one exemplary embodiment of the present invention;

FIG. 2 shows a schematic diagram for elucidating a metallic structure of a material for the component illustrated in FIG. 1, if a grain stabilization does not take place locally; and

FIG. 3 shows a schematic diagram for elucidating a metallic structure of a material for the component illustrated in FIG. 1, if a grain stabilization takes place locally.

### DETAILED DESCRIPTION OF THE INVENTION

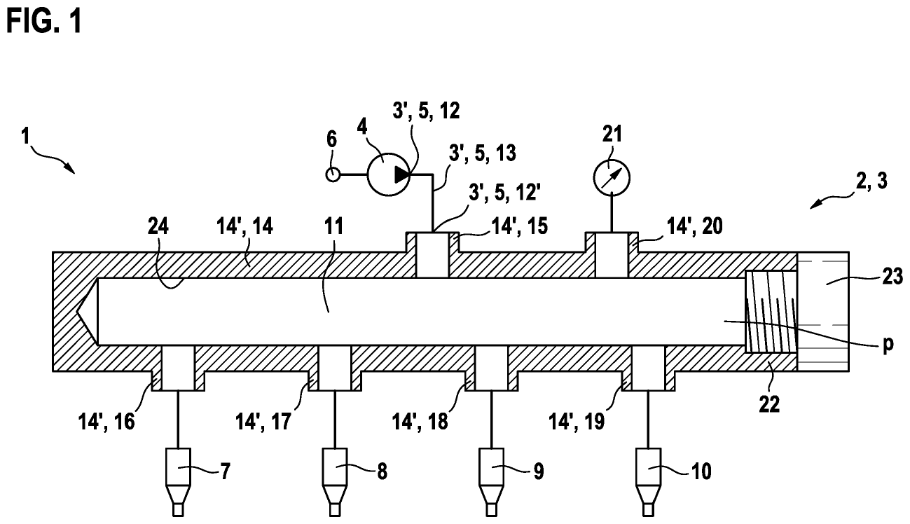

FIG. 1 shows an injection system 1 designed as a fuel injection system 1 including a fuel distributor (fluid distributor) 2 in a schematic sectional illustration according to one exemplary embodiment. In this exemplary embodiment, fuel distributor 2 of fuel injection system 1 is a component 3 designed according to the present invention. Furthermore, a high-pressure pump 4 is provided. High-pressure pump 4 is connected to fuel distributor 2 via a fuel line 5 designed as a high-pressure line 5. At an input 6 of high-pressure pump 4, a fuel or a mixture containing a fuel is supplied as a fluid during operation. In this case, high-pressure line 5 may also correspondingly be designed as a component 3′ according to the present invention.

Fuel distributor 2 is used to store and distribute the fluid to injectors 7 through 10 designed as fuel injectors 7 through 10 and reduces pressure fluctuations and pulsations. Fuel distributor 2 may also be used to dampen pressure pulsations which may occur when fuel injectors 7 through 10 are switched. During operation, high pressures p may occur at least temporarily in an interior 11 of component 3 in this case. High-pressure line 5 includes a high-pressure input 12 and a high-pressure output 12′, which may be potentially switched, as well as a base body 13.

Fuel distributor 2 includes a tubular base body 14 that may be manufactured by forging, for example. At tubular base body 14, a high-pressure input 15 and multiple high-pressure outputs 16 through 19 are provided. Furthermore, a high-pressure terminal 20 is provided at tubular base body 14. In this exemplary embodiment, tubular base body 14, high-pressure input 15, high-pressure outputs 16 through 19, and high-pressure terminal 20 are formed from a forged single part 14′. High-pressure input 15, high-pressure outputs 16 through 19, and high-pressure terminal 20 are thus forged at base body 14.

Fuel line 5 is connected at its high-pressure input 12 to high-pressure pump 4 and at its high-pressure output 13 to high-pressure input 15 of fuel distributor 2. Fuel injectors 7 through 10 are each connected to high-pressure outputs 16 through 19 of fuel distributor 2. Furthermore, a pressure sensor 21 is provided that is mounted at high-pressure terminal 20. At an end 22, tubular base body 14 is closed by a closure 23 designed as a closing screw 23.

In tubular base body 14, a bore 24 is formed after the forging to form interior 11. Via interior 11, the fluid supplied at high-pressure input 15 may be distributed to fuel injectors 7 through 10 connected at high-pressure outputs 16 through 19.

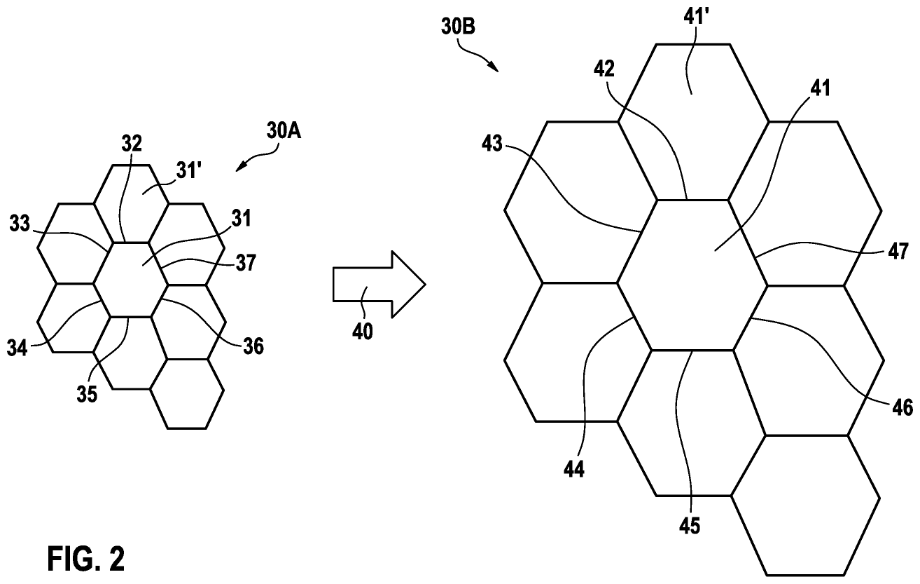

FIG. 2 shows a schematic diagram for elucidating a metallic structure 30A, 30B of a material for component 3, 3′ illustrated in FIG. 1, if a grain stabilization does not take place locally. Initially, the material has structure 30A in its starting state. A grain 31 selected by way of example has grain borders 32 through 37, which are schematically illustrated in this case in the two-dimensional illustration, with regard to its adjacent grains 31′, only grain 31′ being identified in order to simplify the illustration. The material then changes its structure for at least one processing step 40, structure 30B resulting in the treated state. Due to a grain growth, coarse grain formation has resulted in this case. With regard to a grain 41 selected by way of example, grain borders 42 through 47 result with regard to adjacent grains 41′, one of which being identified by way of example.

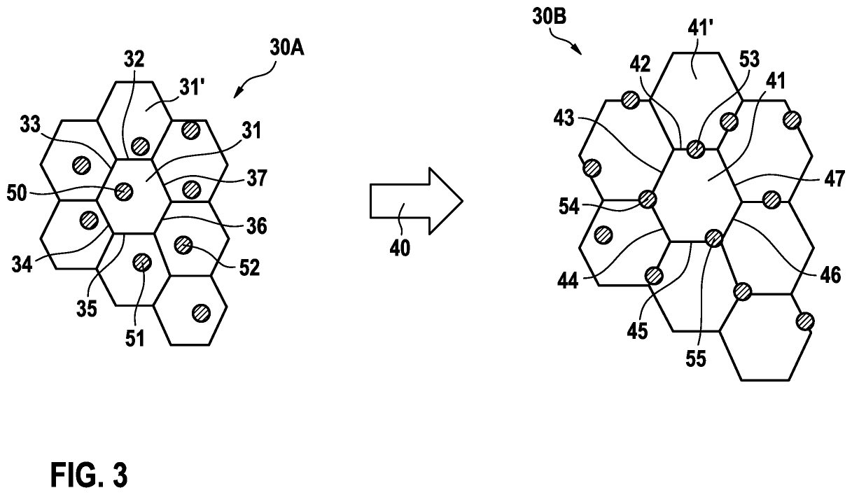

FIG. 3 shows a schematic diagram for elucidating a metallic structure 30A, 30B of the material for component 3, 3′ illustrated in FIG. 1, if a grain stabilization takes place locally. In its starting state, structure 30A has due to the microalloy a plurality of dispersions 50 through 52, of which dispersions 50 through 52 are identified by way of example. Processing step 40 results in structure 30B following the processing or heat treatment. At least a part of the dispersions is then located at the grain borders. With regard to grain 41, dispersions 53 through 55 are located for illustration purposes by way of example at grain borders 42 through 47 that impede a grain growth of grain 41 during processing step 40. In contrast to structure 30B illustrated in FIG. 2, a finer grain 41 thus results in structure 30B (FIG. 3).

A component 3, 3′, in particular a base body 13, 14, is preferably designed in such a way that a possibly homogenous structure 30B results that is grain-stabilized, as is illustrated in FIG. 3.

The present invention is not limited to the described exemplary embodiments.

1-10. (canceled).

11. A component for an injection system, the component being a high-pressure line or a fluid distributor, the component comprising:
a base body at which a high-pressure input and at least one high-pressure output are provided, at least the base body being at least essentially formed from an austenitic or martensitic material, wherein the material is a grain-stabilized material.

12. The component as recited in claim 11, wherein the material is a fine grain-stabilized material.

13. The component as recited in claim 11, wherein the material is grain-stabilized using at least one microalloy.

14. The component as recited in claim 13, wherein the microalloy for the grain stabilization is based on niobium and/or vanadium and/or titanium and/or aluminum.

15. The component as recited in claim 11, wherein the material is grain-stabilized in such a way that a formation of coarse grain is suppressed at least in a temperature range of 850° C. to 1250° C.

16. The component as recited in claim 11, wherein the base body is formed as a forged base body.

17. The component as recited in claim 11, wherein the base body is formed in one piece with the high-pressure input and the at least one high-pressure output from the grain-stabilized material.

18. The component as recited in claim 11, wherein at least the base body is at least partially hardened.

19. The component as recited in claim 11, wherein the material is based on at least one material having a material number 1.4541, or 1.4550, or 1.4580.

20. An injection system for injecting fuel, in particular gasoline and/or ethanol and/or a mixture containing a fuel, comprising:
at least one component including:
a base body at which a high-pressure input and at least one high-pressure output are provided, at least the base body being at least essentially formed from an austenitic or martensitic material, wherein the material is a grain-stabilized material.

21. The injection system as recited in claim 20, wherein the fuel is gasoline and/or ethanol and/or a mixture containing a fuel.

22. The injection system as recited in claim 20, wherein the component is a high-pressure line or a fluid distributor.
